(19) United States
(12) Patent Application Publication
(10) Pub. No.: US 2015/0258475 A1
(43) Pub. Date: Sep. 17, 2015

(54) PRESSURE FILTER

(71) Applicant: Andritz OY, Helsinki (FI)

(72) Inventors: Ilkka Holopainen, Savonlinna (FI); Kari Lappalainen, Savonlinna (FI)

(21) Appl. No.: 14/348,318

(22) PCT Filed: Oct. 3, 2012
(86) PCT No.: PCT/FI12/50946

§ 371 Date: Mar. 28, 2014

(30) Foreign Application Priority Data
Oct. 4, 2011 (FI) 20115973

(51) Int. Cl. B01D 29/90; B01D 36/04; B01D 29/66; B01D 29/13; B01D 29/52

(52) U.S. Cl. CPC B01D 29/908; B01D 29/13; B01D 29/52; B01D 29/66; B01D 36/04

(57) ABSTRACT

A vessel for a pressure filter including: a support plate dividing the interior of the vessel into an upper (filtrate) chamber and a lower chamber; filtering elements extending from the support plate into the lower chamber; a feed cylinder within the lower chamber and below the filtering elements, the feed cylinder including an annular interior surface and a feed opening at the interior surface, wherein the feed opening connects to a feed conduit extending from the feed cylinder to an external source of a pressurized sources of a solids suspension; a horizontal gap between the perimeter of the feed cylinder and the lower chamber, and an outlet conduit below the feed cylinder and configured to discharge from the lower chamber solids from the solids suspension entering the lower chamber through the feed opening in the feed cylinder.

### OBJECT OF THE INVENTION

The present invention relates to a pressure filter for treating solids suspensions comprising a container having a feed conduit for introducing a suspension to be filtered under pressure, and an outlet conduit for discharging the thickened suspension from the bottom of the container, and a plurality of tubular filtering elements suspended from a horizontal support plate, through which elements filtrate flows and the interior of elements which communicates with a filtrate chamber located on the opposite side of the support plate, and the filtrate is arranged to be discharged during a filtering stage via a filtrate outlet conduit exiting from the filtrate chamber, and the filtering elements collect solid matter on their outer surface, which solid matter is arranged to be periodically released by making the filtrate in the filtrate chamber pass counter-currently through the filtering elements and to settle onto the bottom of the container.

### PRIOR ART

When producing chemical pulp by the sulfate method, spent cooking liquor, i.e. black liquor, is evaporated and combusted, and the obtained residual, i.e. so-called soda smelt is dissolved in water to green liquor that contains sodium carbonate and sodium sulfide. Green liquor contains also insoluble substances, such as metal oxides, which are to be removed so that they will not get enriched into the chemical circulation. The separation of so-called green liquor dregs containing these non-process elements from green liquor typically takes place in a clarifier or a filter. The green liquor dregs is thickened and washed usually in a so-called dregs filter. The cleaned green liquor is causticized into new cooking liquor. In the causticizing, the sodium carbonate in the green liquor is let to react with burned lime (CaO) as follows.

White liquor containing sodium hydroxide and calcium carbonate (lime mud) thus obtained are separated and the white liquor is circulated to pulp cooking. The separation of white liquor and lime mud can be performed either in a clarifier or by means of filtration. White liquor filters are typically usual sock (candle) filters or disc filters that are either pressure or vacuum filters. The lime mud is washed for removing alkali therefrom. The lime mud is thickened and washed in a lime mud filter for burning usually in a calcination device, such as a lime kiln, wherein the lime mud is regenerated to burnt lime (calcium oxide) for being returned back to causticizing.

A pressure filter that has long been used at the causticizing plant is a filter that has tubular filtering elements and that is used for lime mud washing and filtering of white liquor and green liquor. The filter is also referred to as a sock filter. Therein a liquor suspension, such as lime milk, is pumped into a pressure vessel, where the liquor passes via tubular filtering elements into a filtrate chamber, while a portion of the solids, such as lime mud, remains on the filtering surface. The coarser fraction settles into the lower part of the filter, which acts as a settling and storing space for the lime mud. When the thickness of the lime mud cake on the surface is adequate (e.g. after 3-5 minutes), the liquor filtrate is made to flow into the opposite direction through the filtering elements (e.g. for 1-10 seconds) for releasing the lime mud cake from the filtering surface. After a short period (typically 30 seconds) the released lime mud begins to settle towards the bottom of the filtering vessel, and a new filtering cycle can begin. Settled lime mud is continuously removed from the bottom of the filtering vessel at a solids content of approximately 40-50% into a washing stage, which usually is dilution washing. Washing liquid is added into the lime mud in a mixing tank, from where the lime mud suspension is pumped to a filter, which may be a similar type of pressure tube filter or a band filter. This kind of pressure filter is disclosed e.g. in U.S. Pat. No. 4,243,533 (FI patent 55937).

The solids suspension to be filtered is typically fed into the upper part of the container in the vicinity of the filtering socks. U.S. Pat. No. 4,528,103 discloses a sock filter, where the feed conduit extends into the interior of the filtering container into the center part. The end of the feed conduit has a funnel-shaped extension, through which the suspension is discharged to the vicinity of the upper end of the sock filters.

When a suspension containing abundantly of solids is introduced in the vicinity of the filtering elements, a risk exists that solid matter remains between the closely located elements, which disturbs both the actual filtering operation and the removing of the solids cake from the surfaces of the elements.

In the filters described above, the part of the filtering container below the filtering elements acts as a settling and storing area. The use of this part of the container can be regarded inefficient, when the actual active filtering operation is concentrated in the upper part.

### DESCRIPTION OF THE INVENTION

An object of the present invention is to eliminate above mentioned problems. An object of the invention is to improve the feed of a solids suspension so that accumulation of solids in locations that disturb the operation of the apparatus is minimized or prevented. An object of the invention is to improve the use of the interior of the filtering container to intensify the filtering.

An essential feature of the present pressure filter is that a cylindrical piece is arranged in the container below the filtering elements and a feed conduit is connected to the cylinder for leading the suspension into the interior of the cylinder.

The cylinder has an open upper surface and an open lower surface. The cylinder is defined by a cylindrical side wall, which typically is vertical. The suspension is led via the open upper part of the cylinder to the filtering elements.

According to a preferred embodiment, the cylinder is a circular cylinder that is concentric with the container and its wall is at a distance from the inner wall surface of the container.

According to an embodiment, the cylinder is located below a middle elevation of the filtering container. The bottom part of the cylinder is located at a distance from the bottom of the container to provide adequate space below the cylinder for the suspension to be removed.

An essential idea of the invention is that the solids-containing suspension is led into the lower part of the filtering container where separation of the solids by settling onto the bottom of the container can start immediately. The coarsest fraction settles the fastest. The settling continues and more material is settled as the suspension passes in the vertical direction towards the filtering elements. Thereby, a portion of the solids is separated from the suspension, prior to the actual filtering. As is known, the suspension has earlier been fed close to the filtering elements, whereby in the vicinity of the filtering elements there is more solid matter that may accumulate therebetween and clog their filtering surfaces faster. The invention utilizes the space below the filtering elements of the filtering container by using it as a pre-settling space during the feeding stage.

The suspension is introduced to a distance from the container wall into the interior of the cylinder part. The solids suspension is introduced into the cylinder via a tangential inlet opening located in the cylinder wall. Thereby, a swirling motion of the suspension is generated, which assists the separation of solids from the suspension during settling.

According to an embodiment, at least one deflector is arranged into the inner wall of the cylinder, or a plurality of deflectors at a distance from each other, such as flow deflection plates, for decelerating the swirling motion of the tangentially fed suspension. The purpose of these swirl deflectors is to decelerate and attenuate the swirl and to guide the flow, whereby solid matter is better released from the suspension and the solids flow directed downwards.

The feed cylinder typically comprises at least two, preferably four parts attached to each other, which are formed by dividing the housing wall of the cylinder vertically to parts. The vertical parts of the cylinder are attached to each other typically with flange joints. Also other joining ways are possible. Thus, it is possible to mount the cylinder into an existing pressure filter, because the cylinder parts can fit into the interior of the filtering container through a manhole.

Said deflector plates can preferably be mounted in connection with the flange joints. They extend from the inner surface of the cylinder into the interior of the cylinder to a desired distance. The mounting angle of the deflector plate is preferably adjustable. It can be used for guiding the tangential flow downwards at an angle of 0-40 degrees, e.g. 5-35 degrees.

According to an embodiment a widening, cylindrical extension is connected to the bottom part of the cylinder, a wall of which extension is perforated. The conical extension part has essentially open upper and lower surfaces. In addition to clarification, this kind of pre-separator can be used for pre-filtering the solids suspension introduced into the cylinder. A portion of the suspension introduced into the cylinder flows into the lower conical part and through its walls so that solid matter remains on the inner surface of the cone. The pre-filtered suspension then flows towards the filtering elements for final filtering. Thereby, more solids from the suspension can settle. Pre-filtering decreases the amount of solids remaining on the filtering elements. The pre-filtered suspension also dilutes the suspension fed into the container with respect to solids, whereby the solid matter of the suspension settles better in the space below the filtering elements.

The filtering cloth of the wall of the pre-filtering part is less dense than the filtering cloth of the filtering elements, since the purpose is to separate coarser material prior to the filtering elements. It also decreases the clogging of the filtering surface of the elements. The filtering surface of the pre-filter is smaller than the filtering surface formed by the filtering elements. The pre-filtering surface can be approximately 5-20% of the area of the filtering elements.

The diameter of the upper edge of the pre-filtering part is smaller than the diameter of the lower edge, typically by approximately 10-40%. The height of the pre-filtering part is greater than the height of the feed cylinder part, typically approximately 2-3 fold. The diameter of the upper edge of the pre-filtering part is essentially as large as the diameter of the feed cyclone. The pre-filter is attached at its upper part to the feed cylinder.

The pressure filter according to the present invention, having a feed cylinder, is advantageously suited for separating white liquor and lime mud, as a lime mud washing filter and for green liquor filtering, especially for polishing filtering of clarified green liquor at a chemical pulp mill. The combination of a cylinder and a conical pre-filter is suitable especially for treating a suspension containing fine-grained solid matter, such as green liquor.

As advantages of the invention can be mentioned: increase of the capacity of the filter, decrease in the solids content of the filtrate, increase in the discharge thickness of the precipitate, extension of the filtration cycle, increased replacement interval of the filtering elements, whereby maintenance costs are decreased, and improved reliability of operation.

An advantage worth mentioning is also a decrease in alkali losses at a causticizing plant of a chemical pulp mill.

FI-patent application 20115262 presents that the interior of the filtering elements is provided with a flow distributor that is arranged above the middle part of a filtering element for distributing the flow led from the filtrate chamber onto the filtration surface of the filtering element. These flow deflector plates further improve the construction according to the present invention, since also the running philosophy of the pressure filters changes. The filtering cycle is extended and the so-called back-flow cycle can be extended if needed, i.e. a capacity increase is obtained.

At a causticizing plant of a chemical pulp mill the invention further allows essential changes in the practice of running the pressure filter. If needed, a portion of the solids suspension, such as lime milk, can thus be fed into the upper part of the pressure filter container as known per se for formation of a precoat, if it is considered necessary in some situation. Alternatively, all the lime milk can be fed into the bottom part of the filter. In a so-called over-calcination situation or when commercial lime is used, the pressure filter operates better, since the clarification space of lime mud is essentially improved by means of this novel feed method.

The solids suspension feed arrangement according to the present invention can also simply be applied for existing pressure filters. The required modification is easy to accomplish in connection with an appropriate shutdown.

### BRIEF DESCRIPTION OF THE DRAWINGS

The present invention is described in more detail by means of a filter embodiment according to the invention and with reference to the accompanying schematic drawings, in which:

FIG. 1 illustrates a prior art pressure filter provided with tubular filtering elements, and the operation thereof;

FIG. 2 is a schematic drawing of a preferred embodiment of a pressure filter according to the invention;

FIG. 3 illustrates in more detail the pressure filter according to the figure along section B-B;

FIG. 4 illustrates as a side view a preferred embodiment of a feed cylinder, and

FIG. 5 illustrates an embodiment of the feed cylinder and the cone connected thereto from above and as a side view.

### DETAILED DESCRIPTION OF THE INVENTION

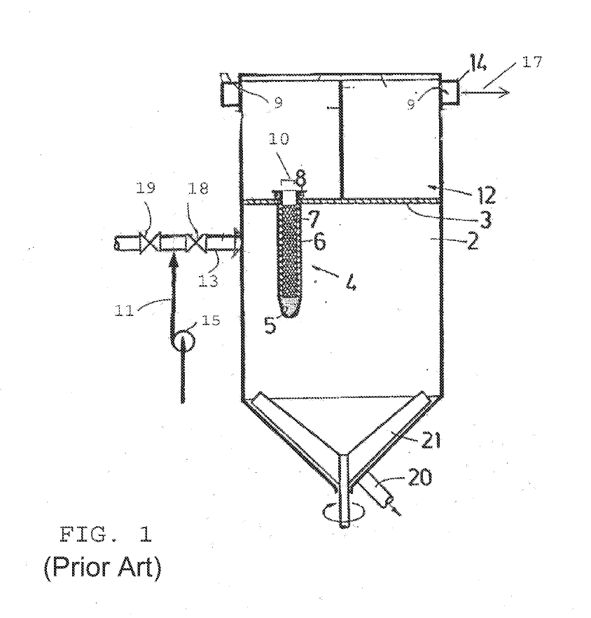

In FIG. 1 the suspension to be filtered, i.e. for instance lime milk containing white liquor and lime mud flows into a filtering container 2 from a lime milk container (not shown) along a feed conduit 11, 13 under the influence of pressure generated by a feed pump 15 in the suspension inlet conduit 11. Then valve 19 is in a closed state and valve 18 open. The container 2 is provided with a horizontal plate 3, from which tubular filtering elements 4 are suspended. The number thereof may be e.g. 200, but only one is shown in the drawings, considerably enlarged. The white liquor of lime milk is filtrated under pressure prevailing in the filtering container 2 through a sock 5 in the filtering element and solids in the lime milk, i.e. lime mud is deposited onto the surface of the filtering sock as a layer 6. The tubular filtering element is formed of a filtering cloth and a solid metallic perforated pipe 7 inside it, which prevents the sock from collapsing. The metal pipe 7 is welded to a flange 8 that is mounted on the horizontal plate 3. The filtrate, i.e. white liquor flows into a filtrate chamber 12 above the plate 3, from which chamber the white liquor flows via an overflow edge or openings 9 into a chute 14 and therefrom via a pipe 17 into further treatment.

The removal of solid matter settled onto the sock 5 is accomplished as follows: The valve 19 is also opened. The hydrostatic pressure of liquid in the filtrate chamber 12 forces the filtrate (white liquor) to flow back through the elements 5, whereby the solids layer 6 is released from the surface of the elements. This cake-removal stage takes e.g. 2-10 seconds. Then follows the settling stage (typically 30 seconds), whereby, the valve 18 is closed and the precipitate begins to settle towards the bottom of the filtering vessel and drops onto the bottom of the container 2. The precipitate exits via discharge pipe 20 and a rotating blade 21 prevents the precipitate from sticking onto the bottom of the container 2. After that begins the filtering stage again, whereby valve 18 is open and valve 19 is closed. The feed pump 15 is not stopped during the stages, but it rotates. In the cake-removal stage the rotations of the pump drop and in the settling stage the pump rotates at a constantly decreasing speed. Just before turning the valves back to the filtration stage, the rotational speed of the pump is increased, so that the pump starts pumping immediately and a so-called back-flow is prevented.

At certain intervals the filter has to be washed. Therefore the filtering container is emptied. The washing takes place in a similar way as the cake-removal, but now washing water, which is acid or water, is introduced through a filtrate manifold, a hot water line or an acid line 17. In acid washing, the acid solution is circulated several times via an acid container (not shown) through a filter. In water washing, the water is taken only once through the filter.

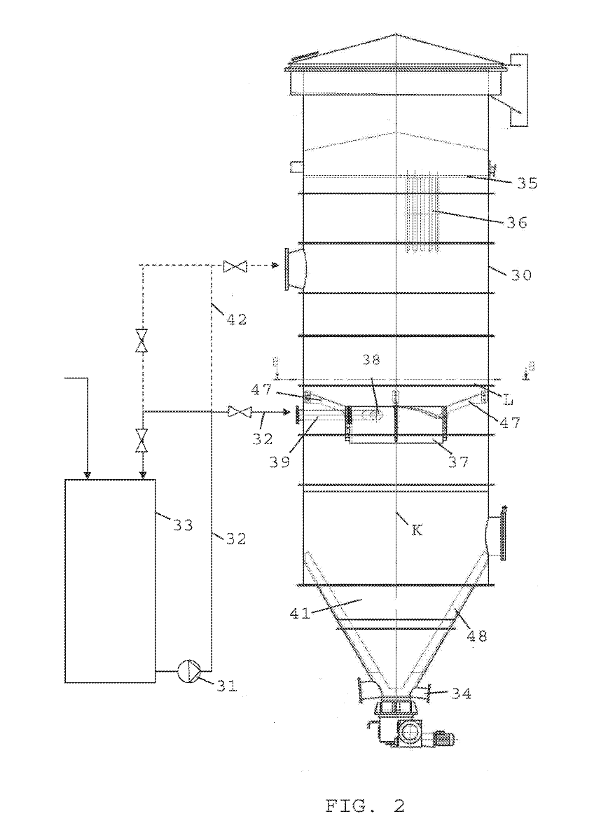

FIG. 2 illustrates an embodiment of the pressure filter according to the present invention.

The filter comprises a container vessel 30 provided with a feed pipe 32 having a feed pump 31 for feeding the suspension to be filtered under pressure into the container from a feed container 33. The bottom of the filter container is provided with a discharge pipe 34 for discharging the thickened suspension from the bottom of the container. A number of tubular filtering elements 36 suspended from a horizontal support plate 35 are located in the upper part of the container. The number thereof may be e.g. 200, but only a few are shown in the drawing. Their structure is typically similar to that described in connection with FIG. 1.

In accordance with the invention, a cylindrical piece 37 is arranged in the container 30 below the filtering elements 36, and a feed pipe 32 is connected to the cylinder via a conduit 39 for leading the solids suspension to be filtered into the interior of the cylinder. According to a preferred embodiment, the cylinder 37 is a circular cylinder that is concentric with the container 30 in relation to the central axis K. The cylinder 37 is located at a distance from the inner surface of the wall of the container 30.

Preferably the cylinder 37 is located below a middle elevation L of the container 30.

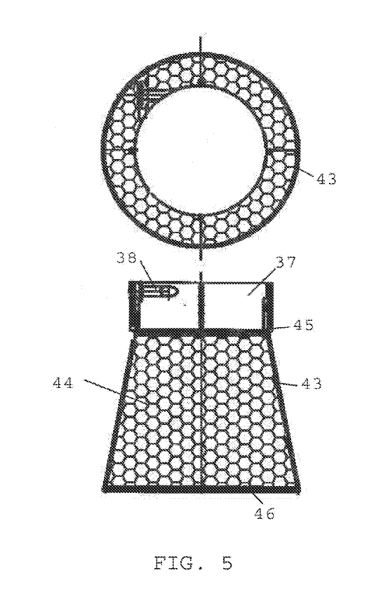

The solids suspension is fed into the cylinder via a tangential feed opening 38 (FIG. 4) in the container wall, which opening is connected to the suspension feed pipe 32 via a conduit 39. By means of tangential feed, a swirling motion of the suspension in the cylinder is accomplished.

According to an embodiment, deflectors are arranged on the inner wall of the cylinder at a distance from each other, such as deflector plates 40, for decelerating the swirling motion of the tangentially fed suspension. The purpose of these swirl deflectors 40 is to decelerate and guide the swirl, whereby solid matter is better released from the suspension.

According to the invention, the solids-containing suspension is led into the lower part of the filtering container where separation of the solids by settling onto the bottom 41 of the container can start immediately. The coarsest fraction settles the fastest. The settling continues and more material is settled as the suspension travels in the vertical direction towards the filtering elements 36. Thereby, a portion of the solids is separated from the suspension, prior to the actual filtering. As is known, the suspension has earlier been fed close to the filtering elements, as shown in FIG. 2 by means of a pipe 42, whereby in the vicinity of the filtering elements 36 there is more solid matter that may accumulate between them and clog their filtering surfaces faster. The invention utilizes the space below the filtering elements of the filtering container by using it as a pre-settling space during the feeding stage. A mixer 48 is located on the bottom of the container, as known per se. The feed cylinder 37 typically comprises at least two, preferably 4 parts 37a and 37b attached to each other (FIG. 4.) These vertical parts of the cylinder are attached to each other typically with flange joints 49. Thus, it is possible to mount the cylinder in parts into an existing pressure filter, because the cylinder parts can fit into the interior of the filter housing through a manhole. The swirl deflection plates can preferably be mounted in connection with the flange joints.

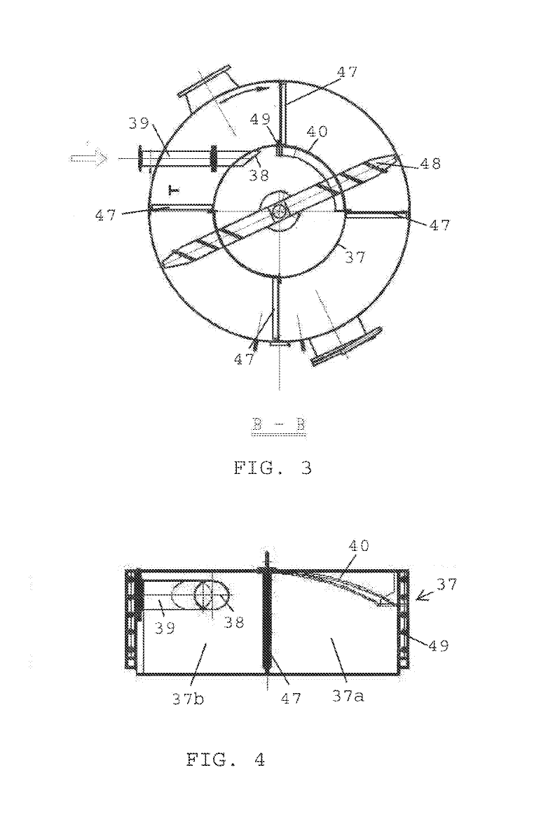

The cylinder 37 is supported to a support structure mounted in the inner wall of the filter. E.g. support rods 47 are mounted at a distance from each other on the inner wall of the container. The cylinder is arranged to be suspended supported from them (FIGS. 2 and 3). FIG. 3, which is a cut view B-B of FIG. 2, illustrates a deflector plate 40 that is attached to a flange 49. The feed cylinder 30 receives the solids suspension to be treated via a conduit 39 and a feed opening 38. A mixer 48 is located on the bottom of the pressure filter vessel, as known per se.

FIG. 5 illustrates an embodiment, in which the bottom part of the cylinder 37 is provided with a conical, downwards widening extension part 43 with a perforated wall 44. The conical extension part has essentially open upper and lower surfaces. In addition to clarification, this kind of pre-separator can be used for pre-filtering the solids suspension introduced into the cylinder. A portion of the suspension introduced into the cylinder flows into the lower conical part and through its walls so that solid matter remains on the inner surface of the cone. The pre-filtered suspension then flows towards the filtering elements for final filtering. Thereby, more solids can settle therefrom.

The filtering cloth of the wall 44 of the pre-filtering cone 43 is less dense than the filtering cloth of the filtering elements 36, since the purpose is to filter off coarser material prior to the filtering elements. It also decreases the clogging of the filtering surface. The filtering surface of the pre-filter is essentially smaller than the filtering surface formed by the filtering elements.

The diameter of the upper edge 45 of the pre-filtering cone 43 is smaller than the diameter of the lower edge 46, typically by approximately 10-40%. This pre-filtering part widens downwards, because thus it allows preventing fine-grained precipitate from rising backwards from the bottom of the container.

The height of the pre-filtering part is greater than that of the feed cylinder part, typically approximately 2-3 fold. The diameter of the upper edge 45 of the pre-filtering part is essentially as large as the diameter of the feed cylinder 37. The pre-filter is at its upper part attached to the feed cylinder by a suitable method, e.g. by welding.

The pre-clarified and possibly pre-filtered suspension flows to the filtering elements 36, through which the filtrate flows. The interiors of the elements 36 communicate with a filtrate chamber 48 located at the opposite side of the support plate 35. The filtrate exits the filtrate chamber during the filtering stage through a filtrate discharge conduit 49 exiting from the filtrate chamber.

The filtering elements 36 collect on their outer surface solid matter that is arranged to be periodically released by making the filtrate in the filtrate chamber pass counter-currently through the filtering surface of the filtering elements, as described in connection with FIG. 1. The precipitate settles onto the bottom 41 of the container.

If needed, a portion of the solids suspension, such as lime milk, can be fed into the upper part of the pressure filter container as known per se for formation of a precoat, if it is considered necessary in some situation. For this purpose, a suspension feed line 42 is connected as known per se to the upper part of the filter.

Although the above description relates to an embodiment of the invention that is in the light of present knowledge considered the most preferable, it is obvious to a person skilled in the art that the invention can be modified in many different ways within the broadest possible scope defined by the appended claims alone.

1. A pressure filter container for treating solids suspensions comprising;
a feed conduit connected to the container and for transporting a flow of a suspension into the container under pressure;
an outlet conduit extending from of the container for discharging a thickened suspension from the bottom of the container;
tubular filtering elements suspended from a horizontal support plate within the container and through said filtering elements filtrate flows, and the interior of said filtering elements is in fluid communication with a filtrate chamber located on the opposite side of the support plate, wherein the filtrate is arranged to be removed during a filtering stage through a filtrate outlet conduit exiting from the filtrate chamber, wherein the filtering elements collect solid matter on their outer surfaces, which solid matter is periodically released by directing the filtrate in the filtrate chamber to flow counter-currently through the filtering elements to dislodge the solid matter, wherein the solid matter settles onto the bottom of the container to be discharged through the outlet conduit; and
a cylindrical piece is arranged in the container below the filtering elements and the feed conduit is connected to the cylinder for leading the suspension into the interior of the cylinder.

2. The pressure filter according to claim 1 wherein the cylindrical piece includes a tangential inlet for the suspension to enter the container.

3. The pressure filter according to claim 1, wherein the cylindrical piece is concentric with the container and is at a horizontal distance from an inner surface of the container wall.

4. The pressure filter according claim 1, wherein the cylindrical piece is located below a middle elevation of the container.

5. The pressure filter according to claim 2, wherein the cylindrical piece includes a deflector arranged on the inner wall of the cylinder and arranged to guide the tangentially fed suspension.

6. The pressure filter according to claim 2, wherein the cylindrical piece includes deflectors arranged at a distance from each other on the inner wall of the cylindrical piece for guiding the tangentially fed suspension.

7. The pressure filter according claim 1 further comprising a conical, downwards widening extension including a perforated wall, wherein the extension is connected to a bottom part of the cylindrical piece.

8. A vessel for a pressure filter comprising:
a support plate dividing the interior of the vessel into an upper chamber and a lower chamber, wherein the upper chamber is a filtrate chamber and includes an outlet for filtrate flowing through the filtrate chamber;
filtering elements extending from the support plate into the lower chamber, wherein fluids flow from the lower chamber, through the filtering elements and into the upper chamber;
a feed cylinder within the lower chamber and below the filtering elements, the feed cylinder including an annular interior surface and a feed opening at the interior surface, wherein the feed opening connects to a feed conduit extending from the feed cylinder through the vessel to an external source of a pressurized sources of a solids suspension;
a horizontal gap between the perimeter of the feed cylinder and the lower chamber, and
an outlet conduit below the feed cylinder and configured to discharge from the lower chamber solids from the solids suspension entering the lower chamber through the feed opening in the feed cylinder.

9. The vessel of claim 8 wherein the horizontal gap is an annular gap and the feed cylinder is coaxial with a vertical axis of the vessel.

10. The vessel of claim 8 wherein the feed conduit is a tangent to the feed cylinder at the feed opening.

11. The vessel of claim 8 further comprising a deflector plate extending radially inward from the interior surface of the feed cylinder and aligned with the feed opening.

12. The vessel of claim 8 further comprising support spokes supporting the feed cylinder and extending from the feed cylinder to the vessel.

13. The vessel of claim 8 further comprising a frustoconical wall extending downward from the feed cylinder, wherein an upper rim of the wall connects to a lower rim of the feed cylinder.

14. The vessel of claim 13 wherein the frustoconical wall is a perforated wall.
